(19) United States
(12) Patent Application Publication
(10) Pub. No.: US 2015/0221054 A1
(43) Pub. Date: Aug. 6, 2015

(54) VIRTUAL PROPERTY SYSTEM

(71) Applicant: Spayce, Inc., San Francisco, CA (US)

(72) Inventors: Patrick COLANGELO, Cambridge, MA (US); Christopher TAYLOR, Minneapolis, MN (US)

(21) Appl. No.: 14/523,835

(22) Filed: Oct. 24, 2014

Related U.S. Application Data
(63) Continuation of application No. 14/171,575, filed on Feb. 3, 2014.

(51) Int. Cl. G06Q 50/18; G06Q 50/16; G06Q 50/00; G06Q 20/10

(52) U.S. Cl. CPC G06Q 50/184; G06Q 20/10; G06Q 50/16; G06Q 50/01

(57) ABSTRACT

A virtual property system for collecting content files associated with a physical object having a unique identifier includes a server that is connected to a network. The server has at least a first non-transitory computer-readable storage medium and is adapted to define a virtual property associated with the physical object. The server includes a content acquisition module that captures a plurality of the content files, a moderating module that provides moderating access rights of the content files; a payment module that collects payment from the moderator, a display module adapted to display a status of each virtual property, and a content playback module for enabling presentation of any of the content files associated with the virtual property on a portable electronic device of a user who is within a predetermined distance of the physical object.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to computer file playback and display systems, and more particularly to virtual property system for associating a plurality of content files related to a physical object with a virtual property.

### DISCUSSION OF RELATED ART

Facebook and other social media sites allow for their users to upload content files, such as images, videos, and other files, so that their users can share such files with their friends, family and other contacts. Such files are generated at a physical location, such as a theme park, nightclub, restaurant, park, residence, or other physical place. In the case where such content files are generated at a business establishment, such as a nightclub or theme park, many patrons of such a location generating such files over time can result in a significant collection of content files associated with the establishment. As such, the owner or manager of the location has an interest in promoting the best such content files for the purpose of marketing the establishment to other potential customers and also to repeat customers. Such a collection of content files, therefore, has a value and can be marketed to the business owner or others interested in having moderating rights of the collection of files.

Google Maps and other services allow users to geographically tag image files, such as image files associated with a landmark or other physical location, on a map. However, the display of such image files is not controllable by the manager or owner of the location. Further, the users who have uploaded such files to such services permit the files to be displayed publically to anyone, and often users would rather their files are only shown privately, amongst friends, or publicly only at the location where the files were generated.

Therefore, there is a need for a system that allows photos, videos and similar files that are associated with a physical object, such as a geographic location, business, landmark, or the like, to be collected into a virtual property. Such a virtual property would be moderated by a moderator who purchases the rights to moderate the property, thereby being able to control the display of content files at the location and the presentation of the location on a property page displayed to users who visit the location. Moderation rights could be bought and sold, the price appreciating as more and higher-quality content files are added to the collection. The present invention accomplishes these objectives.

### SUMMARY OF THE INVENTION

The present invention is a virtual property system for collecting content files associated with a physical object, such as a physical landmark on a real property, for example. The physical object has a unique identifier such as a physical mailing address. The physical object may coincide with the real property, such as a business establishment, a residence, a public property such as a park, or the like. Alternately, the physical object may be a specific location within the real property, such as a specific attraction at a theme park, for example. As such, each real property may include any number of the physical objects.

The system includes a server that is connected to a network, such as the Internet. The server has at least a first non-transitory computer-readable storage medium and is adapted to define a virtual property associated with the physical object using the unique identifier. The server includes a content acquisition module that captures a plurality of the content files that are accessible on the network and stores the content files into the first non-transitory computer-readable storage medium. Each content file may be a processor-readable file, such as a text file, an image file, a video file, an audio file, or the like.

The server includes a moderating module that provides, to a moderator with access to the server through the network, moderating access rights to the content files and metadata thereof. Such moderating access includes enabling the moderator to edit the metadata of the content files, to delete the content files, to provide access rights for others wishing to view or playback the content files, and to establish and maintain metadata for the virtual property that includes at least a virtual property name and a virtual property image file.

In one embodiment, the moderating access includes enabling the moderator to promote selected content files as featured files for priority playback or display to other users having access to the server through the network. Further, the moderating access rights may include enabling the moderator to share a subset of his moderating rights with other co-moderators at his discretion.

The server includes a payment module that collects payment from the moderator for an initial set-up of the moderator with moderating access to the virtual property and/or for collecting recurring payments for maintaining moderating access to the virtual property. The payment module may be adapted to list the users on the network that the virtual property administrating rights are “for sale” for a transfer price, and to facilitate a transaction for the virtual property administrating rights between a buyer and the current moderator.

The server may further include a display module adapted to display a status of each virtual property including if the virtual property currently has an assigned moderator or if the virtual property is being offered for sale, and the associated transfer fee and metadata of the virtual property. A list of all virtual properties may be displayed by the display module through the network, including their status and, if being offered for sale, the transfer price. The list may be displayed as a text list, on a map that shows the virtual boundary of each property and its status, or in any other suitable manner.

The server preferably further includes a content playback module at last partially resident on a portable electronic device (PED) of a user. Such a PED is in communication with the server through the network. The content playback module is adapted for enabling presentation of any of the content files associated with the virtual property on the PED only while the PED is within a predetermined distance of the virtual property, as determined by a location services module. The location services module is at least partially resident on the PED and is adapted for determining a geographic location of the PED and communicating same to the server. The server is adapted to calculate the distance between the PED and the virtual property.

Preferably the payment module is adapted to list to users on the network the virtual property administrating rights as being “for sale” for the transfer price, and to initiate a transaction for the virtual property administrating rights between the buyer and the current moderator only if the buyer is located within the predetermined distance of the virtual property, as determined by the location services module.

The content playback module preferably operates on the user's PED so that when the user enters the virtual property, or comes within the predetermined distance of the object, a property page is displayed on the user's PED, indicating the metadata for the virtual property such as the virtual property name, the virtual property image file, and a list of the featured files or other enabled content files. The user may then select any of the featured files or content files for display or playback on the PED. The property page may also indicate if the virtual property is being offered “for sale” and its transfer price.

The first time that a user enters the virtual property, he is preferably asked to register by providing contact information so that the system or moderator may contact him in the future. Further, user preferences and settings may be established by the user as to what information and content files of the user may be publicly shared.

In use, the virtual property may be established by the server and associated with the physical object through the unique identifier of the physical object. The content acquisition module captures and saves content files associated with the physical object and/or the virtual property. The moderator is then enabled to control access to the content files and the metadata.

The moderating rights for each virtual property may be bought and sold, with the server calculating an estimated worth of the virtual property based on a measured number of visits of the virtual property through the network, the number of physical users viewing the property page, the average duration of each user's physical visit to the object, the average amount of money spent by each user per visit, the number of content files associated with the virtual property, the popularity of the content files, and other factors as may be suitable. The system may determine a maximum number of virtual properties that any particular moderator may own the rights to moderate, and may also offer advertising opportunities for moderators desiring to sell their moderating rights.

The present system and method a system allows photos, videos and similar files that are associated with a physical object, such as a geographic location, business, landmark, or the like, to be collected into a virtual property. Such a virtual property is moderated by a moderator who purchases the rights to moderate the property, thereby being able to control the display of content files at the location and the presentation of the location on a property page displayed to users who visit the location. Moderation rights are bought and sold, the price appreciating as more and higher-quality content files are added to the collection. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a top plan view of a plurality of real properties and associated virtual properties of the system of the present invention;

FIG. 2 is a diagram of components of the system of the present invention;

FIG. 3 is an alternate diagram of the system;

FIG. 4 is an example interface screen of an app running on a user's portable electronic device, wherein the user is offered to buy moderating rights to a virtual property;

FIG. 5 is an example interface screen showing a list of properties to which the user has purchased moderating rights;

FIG. 6 is an example interface screen showing a dashboard for the user to select properties that he owns in a list format, a map format, or to select an on-line marketplace for buying and selling the virtual properties' moderating rights; and

FIG. 7 is an example interface screen showing a virtual property page.

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list. When the word “each” is used to refer to an element that was previously introduced as being at least one in number, the word “each” does not necessarily imply a plurality of the elements, but can also mean a singular element.

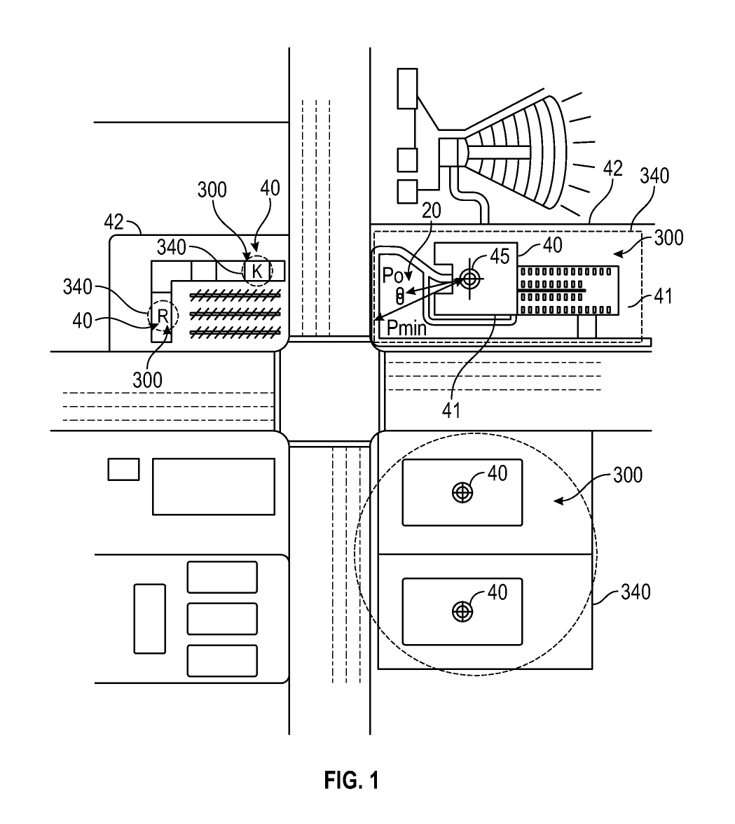

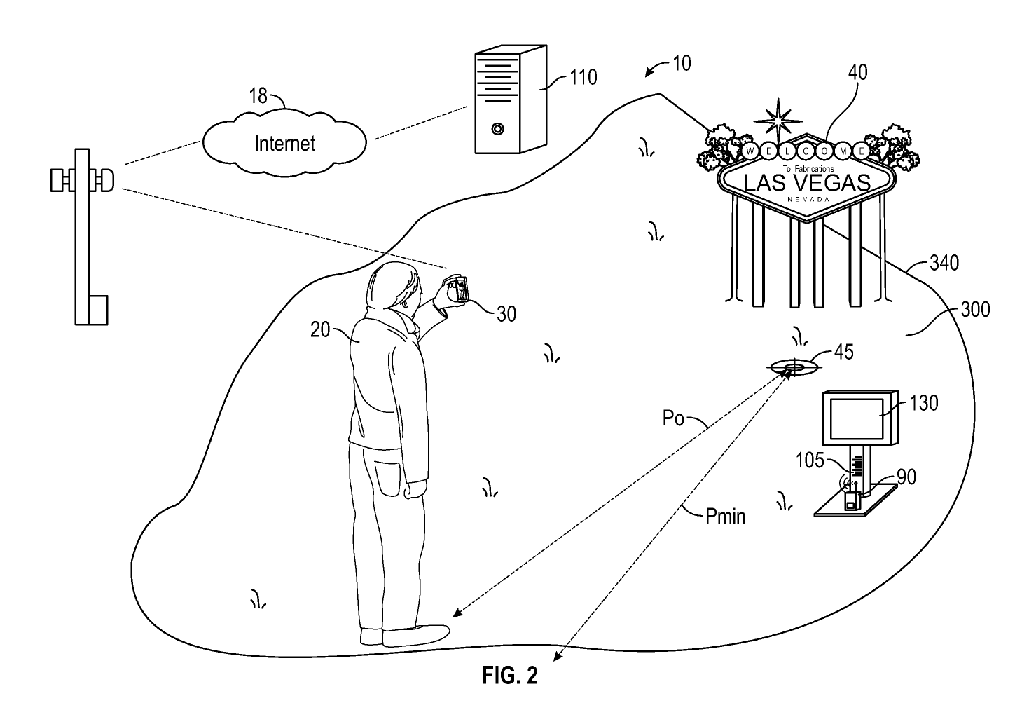

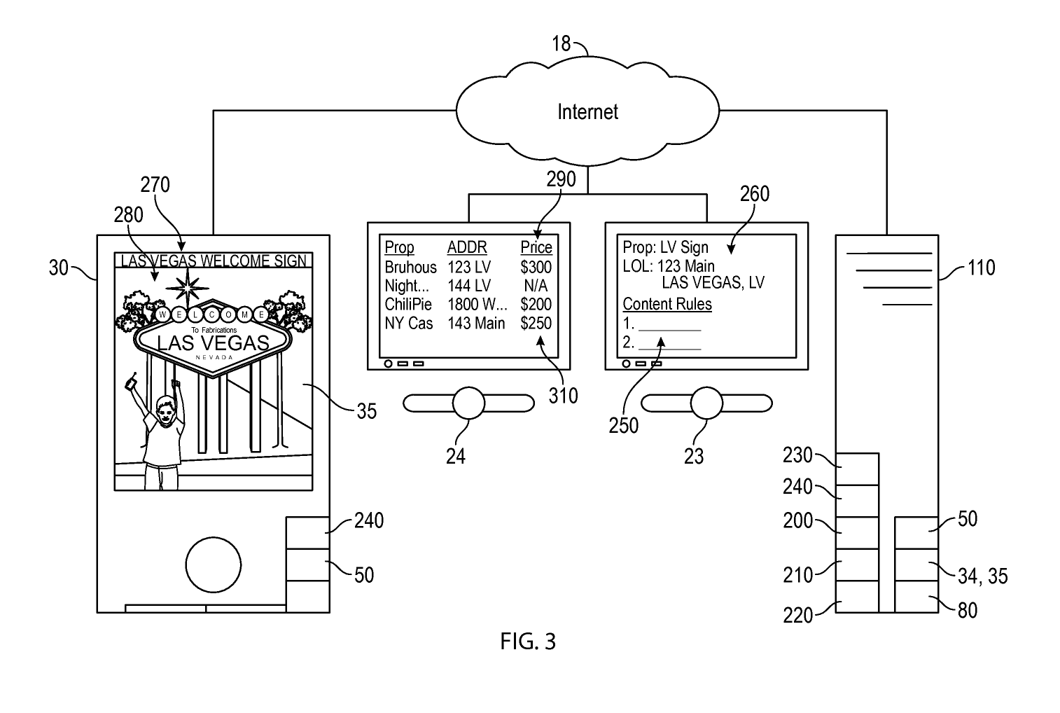

FIGS. 1-3 illustrate a virtual property system 10 for collecting content files 15 associated with a physical object 40, such as a physical landmark on a real property 41, for example. The physical object 40 has a unique identifier 45 such as a physical mailing address, geographic coordinates such as longitude/latitude coordinates, or the like, which can be used to uniquely identify the physical object 40. The physical object 40 may coincide with the real property 41, such as a business establishment, a residence, a public property such as a park or beach, or the like. Alternately, the physical object 40 may be a specific location within the real property, such as a specific attraction at a theme park, for example. As such, each real property 41 may include any number of the physical objects 40.

The system 10 includes a server 110 that is connected to a network 18, such as the Internet, a cellular phone network, or the like. The server 110 has at least a first non-transitory computer-readable storage medium 80 and is adapted to define a virtual property 300 associated with the physical object 40 using the unique identifier 45. The system 10 may be embodied within the non-transitory computer-readable storage medium that is part of a user's portable electronic device (PED) 30, or part of the server 110, or both. The system 10 is implemented with a set of computer readable instructions 34, or an application 11 (a so-called “app”), that, when executed by at least one processor 35 of the PED 30 and/or the server 110, cause the at least one processor 35 to perform the operations.

The virtual property 300 may include a virtual boundary 340 that corresponds to a physical property line 42 of the real property 41 that contains the physical object 40, the physical object 40 being in this case stationary. In such cases, the virtual property moderating rights may be included with the physical property rights during a real estate sale of the real property 41. Alternately, the virtual boundary 340 may not correspond to any physical property line 42 of any real property 41, but instead just be associated with the physical object 40. For example, one virtual property 300 may be associated with a specific attraction at a theme park that has multiple virtual properties with other physical objects 40. Alternately, the virtual property 300 may encompass a multiple number of whole or partial real properties 41, such as a neighborhood having a multiple number of real properties 41 that all display holiday lighting, for example. A virtual property 300 may be defined generally as an overall venue, whether it encompasses multiple real properties 41, just a single real property 41, or only a portion of one real property 41.

The server 110 includes a content acquisition module 200 that captures a plurality of the content files 15 that are accessible on the network 18 and stores the content files 15 into the first non-transitory computer-readable storage medium 80. Each content file 15 may be a processor-readable file, such as a text file, an image file, a video file, an audio file, or the like. The content acquisition module 200 may capture the content file 15 in its entirety on the storage medium 80, or just capture a network link, such as a URL or IP address, to the content file 15 if there is a question of copyright laws allowing the server 110 to copy the content file 15.

The content acquisition module 200 may acquire the content file 15 from the content enablement system of our previously-filed U.S. patent application Ser. No. 14/164,197, filed on Jan. 25, 2014 and incorporated herein by reference. The content acquisition module 200 may also acquire the content file 15 from social media sources such as Facebook, Twitter, Instagram, and the like, provided that such content files 15 are able to be associated with the physical object 40 or the virtual property 300. Further, a content file 15 may be directly uploaded to the sever 15 from a user 20 through the network 18, or through a dedicated email address associated with the virtual property, or through a dedicated hashtag, phone number, or other means of unique digital contact. The content acquisition module 200 may also acquire content files 15 from news sources, blogs, or other publicly-available sources accessed on the network 18.

For example, a user 20 may be able to sign into the server 110 through his Facebook account, which provides access of the content acquisition module 200 to the content files of the user 20 on Facebook. If such a content file 15, such as one of the user's photos or videos, is tagged as being at a particular venue associated with the physical object 40 or virtual property 300, or is otherwise geographically tagged as being within the predetermined distance Pₘᵢₙ of the object 40 or the virtual property 300, then the content acquisition module 200 may copy the content file 15 to the first non-transitory computer-readable storage medium 80, preferably after obtaining permission from the user 20. The user 20 may determine if the content file 15 may be publicly shared, and if so, the content acquisition module 200 associates the content file 15 with the physical object 40 and/or the virtual property 300. For example, if the virtual property 300 includes a plurality of physical objects 40, then the content file 15 may preferentially be associated with the physical object 40, whereas if the virtual property 300 only contains one physical object 40, then the content file 15 may be associated with virtual property 300 or both the virtual property 300 and the physical object 40. The content acquisition module 200 preferably also associates the content file 15 with the user 20 who owns or generated the content file 15.

The server 110 includes a moderating module 210 that provides, to a moderator 23 with access to the server 110 through the network 18, moderating access of the content files 15 and metadata 250 thereof. Such moderating access includes enabling the moderator 23 to edit the metadata 250 of the content files 15, to delete the content files 15, to provide access rights for others wishing to view or playback the content files 15, and to establish and maintain metadata 260 for the virtual property 300 that includes at least a virtual property name 270 and a virtual property image file 280.

For example, the moderator 23 may determine that a content file 15 associated with the virtual property 300 is not appropriate for public display, and therefore either disable or delete the content files 15. The moderator 23 is allowed to edit a metadata name 250 of the content file 15, for example, if such a name doesn't already exist or if the current name is unsuitable for some reason as determined by the moderator 23.

In one embodiment, the moderating access includes enabling the moderator 23 to promote selected content files as featured files 320 for priority playback or display to other users 20 having access to the server 110 through the network 18. Further, the moderating access rights may include enabling the moderator 23 to share a subset 330 of his moderating rights with other co-moderators 25 at his discretion. For example, in the case where the physical object 40 is a business establishment such as a nightclub, and the virtual property 300 includes those content files 15 that are associated with users 20 of the nightclub, the moderator 23 may be the owner of the nightclub who delegates certain moderating rights to a co-moderator 25, such as a manager of the nightclub. The co-moderator 25 may be allowed to designate the features files 320 for example, and rename the content files 15, but the co-moderator 25 may be prevented from deleting the content files 15 or changing the metadata 260 associated with the virtual property 300 itself, such as the name 270 of the virtual property 300 or the virtual property image file 280.

The server 110 includes a payment module 220 that collects payment from the moderator 23 for an initial set-up of the moderator 23 with moderating access to the virtual property 300 and/or for collecting recurring payments (i.e., “virtual property taxes”) for maintaining moderating access to the virtual property 300. The payment module 220 may be adapted to list the users 20 on the network 18 that the virtual property administrating rights are “for sale” for a transfer price 290, and to facilitate a transaction for the virtual property administrating rights between a buyer 24 and the current moderator 23. Initially the current moderator 23 of each virtual property 300 may be the owner of the system 10, for example, and initially all or selected defined virtual properties 300 may be offered for sale. Thereafter, the owner of the system 10 may take a percentage of each subsequent transfer from the current moderator 23 to the buyer 24, or not, as desired by the owner of the system 10. The owner of the system 10 may determine minimum transfer prices 290 for each virtual property 300.

The payment module 220 preferably transacts an initial, maintenance or transfer payment through a network-connected credit card payment gateway, PayPal-type payment systems, Bitcoin-type payment systems, or the like. However, manual cash, check or other transactions may be handled directly between the buyer 24 and the current moderator 23 if desired, with the current moderator indicating such to the server 110 so that the transaction may be properly accounted for.

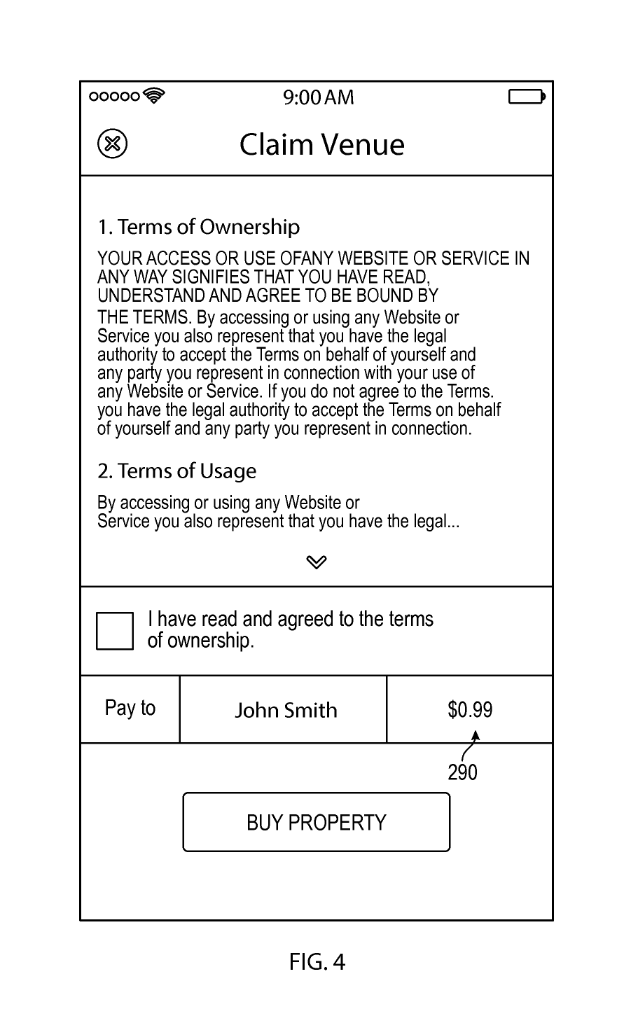

The payment module 220 preferably facilitates any transactions with the moderator 23 or the buyer 24, and in addition to direct transactions may also utilize an auction format, a lottery format, a transaction brokered by virtual property sales agents for a sales commission, or by other known means. The payment module 220 preferably can facilitate such transactions through the network 18 with any remote PED 30 (FIG. 4), any desktop or laptop computer, or other suitable device connected to the network 18. Preferably the payment module 220 is adapted to maintain the secrecy of any parties involved in such a transaction, unless such identities are required to be made known for tax or other legal reasons.

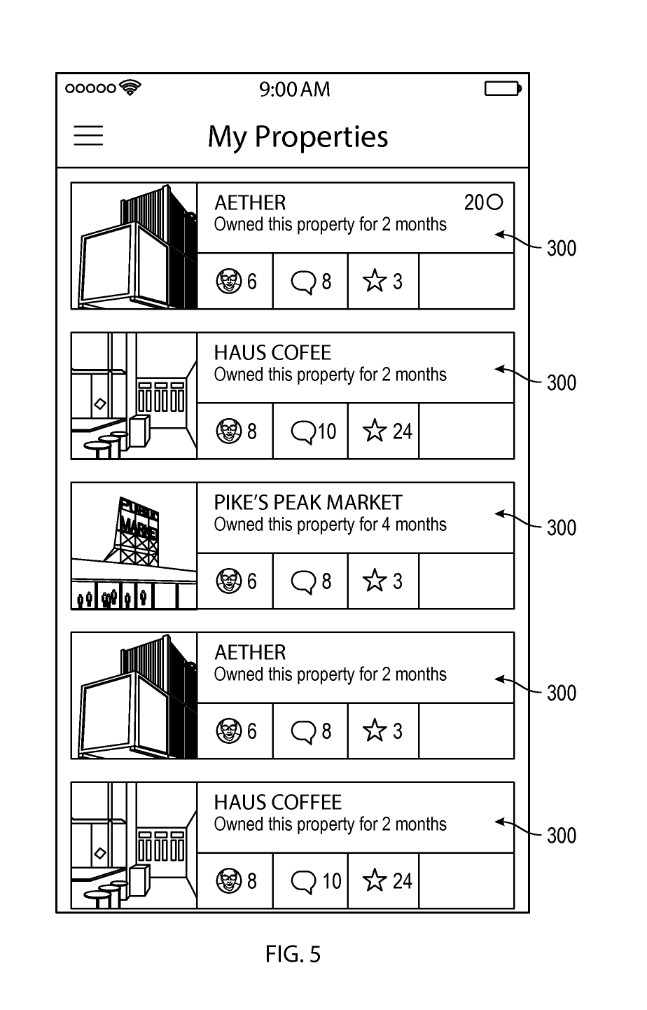

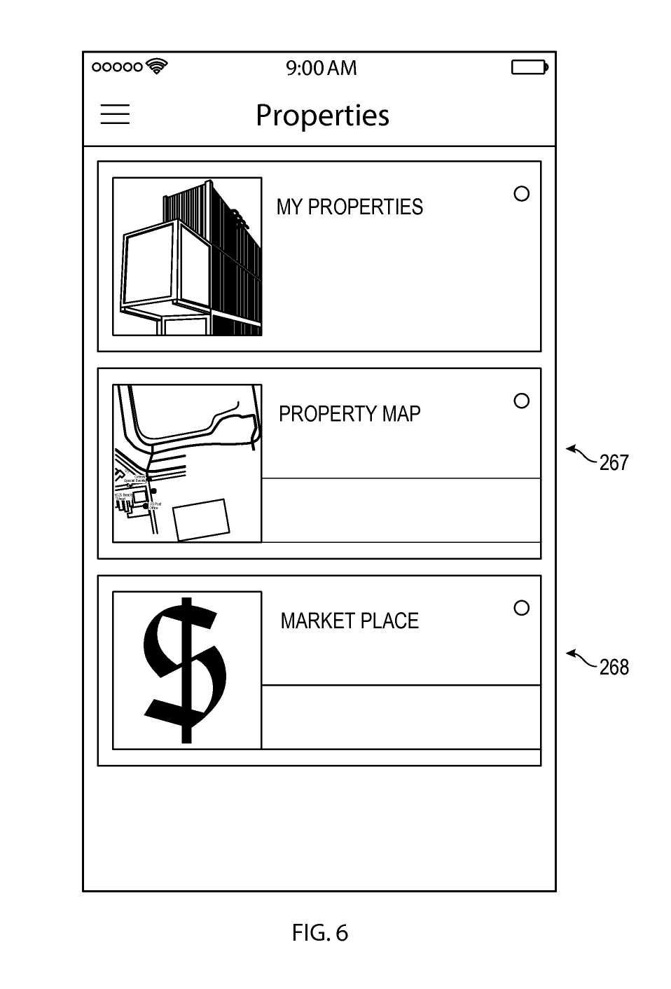

The server 110 may further include a display module 230 adapted to display a status 310 of each virtual property 300 including if the virtual property 300 currently has an assigned moderator 23 or if the virtual property 300 is being offered for sale, and the associated transfer fee 290 and metadata 260 of the virtual property 300. A list of all virtual properties 300 may be displayed by the display module 230 through the network 18, including their status 310 and, if being offered for sale, the transfer price 290. The list may be displayed as a text list, on a map (not shown) that shows the virtual boundary 340 of each property and its status 310, or in any other suitable manner. The display module 230 may also display a list of the user's properties 300 on his PED 30 (FIG. 5), and offer the user 20 an interface screen allowing the user 20 to review his list of properties 300, find new properties on a property map 267, or visit an on-line marketplace 268 for buying and selling properties (FIG. 6).

The server 110 preferably further includes a content playback module 240 at last partially resident on the portable electronic device (PED) 30 of the user 20. Such a PED 30 is in communication with the server 110 through the network 18. The content playback module 240 is adapted for enabling presentation of any of the content files 15 associated with the virtual property 300 on the PED 30 only while the PED 30 is within a predetermined distance Pₘᵢₙ of the virtual property 300, as determined by a location services module 50. The location services module 50 is at least partially resident on the PED 30 and is adapted for determining a geographic location Pₒ of the PED 30 and communicating same to the server 110. The server 110 is adapted to calculate the distance between the PED 30 and the virtual property 300. When the user 20 is within the predetermined distance Pₘᵢₙ of the virtual property 300, the user is said to have entered the virtual property 300, or visited the virtual property 300.

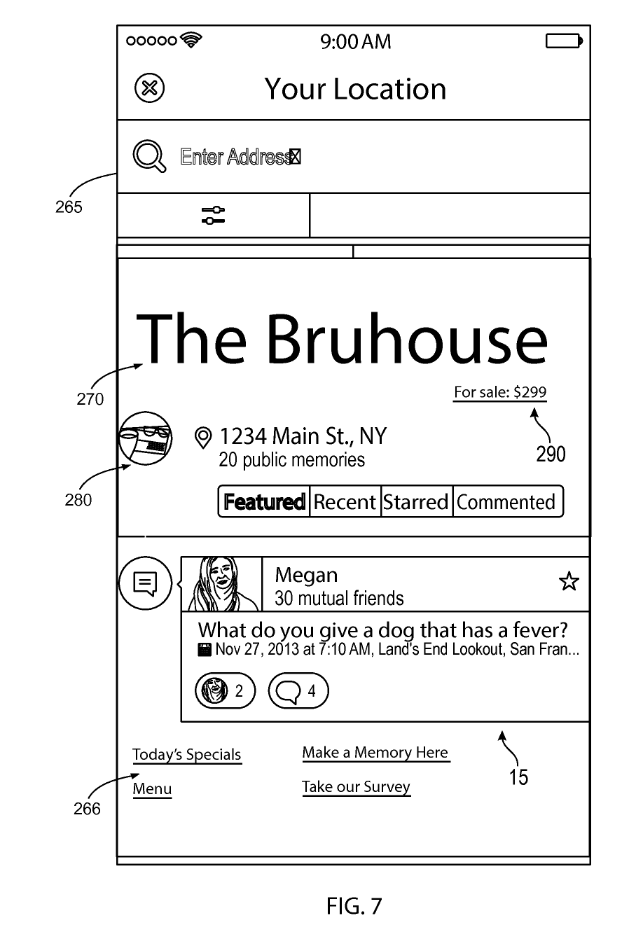

Preferably the payment module 220 is adapted to list to users 20 on the network 18 the virtual property administrating rights as being “for sale” for the transfer price 290, and to initiate a transaction for the virtual property administrating rights between the buyer 24 and the current moderator 23 only if the buyer 24 is located within the predetermined distance Pₘᵢₙ of the virtual property 300, as determined by the location services module 50 (FIGS. 1 and 7).

The content playback module 240 preferably operates on the user's PED 30 so that when the user 20 enters the virtual property 300, or comes within the predetermined distance Pₘᵢₙ of the object 40, a property page 265 is displayed on the user's PED 30, indicating the metadata 260 for the virtual property 300 such as the virtual property name 270, the virtual property image file 280, and a list of the featured files 320 or other enabled content files 15. The user 20 may then select any of the featured files 320 or content files 15 for display or playback on the PED 30. The property page 265 may also indicate if the virtual property 300 is being offered “for sale” and its transfer price 290 if so.

The first time that a user 20 enters the virtual property 300, he is preferably asked to register by providing contact information so that the moderator 23 may contact him in the future. Further, user preferences and settings may be established by the user 20 as to what information and content files 15 of the user 20 may be publicly shared.

Preferably the property page 265 includes links 266 to other optional pages as set-up by the moderator 23, such as a food or drink menu, discounts page, other special offers as appropriate for the virtual property 300, an on-line shopping cart or food ordering system, web-based links, or the like. The property page 265 may also list other users 20 who are present at the object 40 with links to any of the content files to which the other users 20 are associated, provided the other users 20 permit such in a user preferences page (not shown). Optionally, one user 20 may be able to send another user 20, both being physically present at the object 40, a message, a drink, or some other communication or item. The server 110 can accomplish such a transaction as one user 20 buying another user 20 a drink at a nightclub, for example, remotely through the network 18 via the content playback module 240, the payment module 220, as determined by the moderator 23 enabling such functionality for the virtual property 300.

In one embodiment, a presentation system 130 may be established proximate the object 40 and adapted to receive and present the content files 15 associated with the object 40. Such content files 15 are delivered to the presentation system 130 by the server 110 through the network 18, and may be displayed in a substantially random manner, a sequential manner, or other sort order as determined by the moderator 23. Alternately, the server 110 may deliver only content files 15 wherein the user 20 who generated the content file 15 is present at the location of the object 40, ie., within the predetermined distance Pₘᵢₙ of the object 40, or a mix of content files 15, featured files 320, and content files 15 generated by users 20 currently at the location.

In use, the virtual property 300 may be established by the server 110 and associated with the physical object 40 through the unique identifier 45 of the physical object 40. The content acquisition module 200 captures and saves content files 15 associated with the physical object 40 and/or the virtual property 300. The moderator 23 is then enabled to control access to the content files 15 and the metadata 250,260.

The moderating rights for each virtual property 300 may be bought and sold, with the server 110 calculating an estimated worth of the virtual property 300 based on a measured number of visits of the virtual property 300 through the network 18, the number of physical users 20 viewing the property page 265, the average duration of each user's physical visit to the object 40, the average amount of money spent by each user 20 per visit, the number of content files 15 associated with the virtual property 300, the popularity of the content files 15, and other factors as may be suitable. The system 10 may determine a maximum number of virtual properties that any particular moderator 23 may own the rights to moderate, and may also offer advertising opportunities for moderators 23 desiring to sell their moderating rights.

While a particular form of the invention has been illustrated and described, it will be apparent that various modifications can be made without departing from the spirit and scope of the invention. Accordingly, it is not intended that the invention be limited, except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

1-24. (canceled)

25. A system comprising:
a computer processor;
a content acquisition module executing on the computer processor and configured to enable the computer processor to:
generate a virtual property that uniquely corresponds with a physical object, wherein the virtual property has a virtual boundary based on a physical boundary of the physical object;
associate a unique identifier of the physical object with the virtual property, wherein the unique identifier uniquely identifies the geographical location of the physical object;
receive, from one or more client devices, a set of content files associated with the unique identifier;
associate the set of content files with the virtual property based on the unique identifier;
receive, from a client portable electronic device, a request for content files associated with the virtual property;
determine that the client portable electronic device is within a predetermined distance from the physical object; and
upon the determination, provide the set of content files associated with the virtual property to the client portable electronic device.

26. The system of claim 25, wherein the content acquisition module is further configured to:
determine that the set of received content files are related to the virtual property before associating the set of content files with the virtual property; and
storing the received content files.

27. The system of claim 25, wherein the physical object is at least one selected from a group consisting of real property, a physical landmark on real property, a business establishment, a residence, and public property.

28. The system of claim 25, wherein the unique identifier comprises at least one selected from a group consisting of a physical mailing address and geographic coordinates.

29. The system of claim 25, wherein the set of content files comprises at least one selected from a group consisting of a text file, an image file, a video file, and an audio file.

30. The system of claim 25, wherein the physical boundary of the virtual boundary corresponds to a physical boundary line.

31. The system of claim 25, wherein the physical boundary of the virtual boundary is associated with the physical object.

32. The system of claim 25, wherein the content acquisition module is further configured to establish, for a moderating user account of a virtual property platform, moderating access rights for the virtual property and the set of content files.

33. The system of claim 32, further comprising:
receive and storing visitor statistics, wherein the visitor statistics include for each visit of a visiting user account of a portable electronic device within the predetermined distance from the virtual property:
a visitor identification code, a visit start time and date, a visit duration and/or a visit end time and date, and a pointer to or copy of any content files generated by the visitor during the visit; and
provide access to the visitor statistics to the moderating user account.

34. A computer-implemented method comprising:
generating, by a computer processor, a virtual property that uniquely corresponds with a physical location, wherein the virtual property has a virtual boundary based on a physical boundary of the physical location;
associating a unique identifier of the physical location with the virtual property, wherein the unique identifier uniquely identifies the geographical location of the physical location;
receiving, from one or more client devices, a set of content files associated with the unique identifier;
associating the set of content files with the virtual property based on the unique identifier;
receiving, from a client portable electronic device, a request for access to content files associated with the virtual property;
determining that the client portable electronic device is within a predetermined distance from the virtual boundary; and
upon the determination, providing the set of content files associated with the virtual property to the client portable electronic device.

35. The computer-implemented method of claim 34 further comprising:
establishing, for a user account of a virtual property platform, moderating access rights for the virtual property and the set of content files.

36. The computer-implemented method of claim 34 further comprising:
in response to a status request from a user account of a virtual property platform, providing a status of the virtual property indicating whether the moderating access rights are currently assigned to another user account, whether the moderating access rights of the virtual property are currently offered for sale, and a sale price; and
offering, to the user account, the sale of an initial set-up of the moderating access rights and/or recurring moderating access rights.

37. The computer-implemented method of claim 36 wherein the offering to the user account the sale of an initial set-up of the moderating access rights and/or recurring moderation access rights only occurs when a portable electronic device of the user account is within a predetermined distance of the virtual boundary.

38. The computer-implemented method of claim 36 further comprising:
establishing moderating access rights for the user account upon receiving payment for the initial set-up of the moderating access rights and/or the recurring moderation access rights.

39. The computer-implemented method of claim 34 wherein the moderating access rights include enabling a moderating user account to edit metadata of the set of content files, to delete the set of content files, to provide access rights for other user accounts requesting to view or playback the set of content files, to promote certain content files, and to establish and maintain metadata for the virtual property.

40. The computer-implemented method of claim 39, wherein the moderating access rights further include the ability to share a subset of the moderating access rights with other user accounts.

41. The computer-implemented method of claim 34 wherein the physical boundary of the virtual boundary corresponds to a physical boundary line.

42. The computer-implemented method of claim 34 wherein the physical boundary of the virtual boundary is associated with the physical location.

43. The computer-implemented method of claim 34 further comprising:
receiving and storing visitor statistics, wherein the visitor statistics include for each visit of a visiting user account of a portable electronic device to within the predetermined distance from the virtual boundary:
a visitor identification code, a visit start time and date, a visit duration and/or a visit end time and date, and a pointer to or copy of any content files generated by the visitor during the visit; and
providing access to the visitor statistics to a moderating user account.

44. A non-transitory computer-readable storage medium comprising a plurality of instructions configured to execute on at least one computer processor to enable the computer processor to:
generate a virtual property that uniquely corresponds with a physical object, wherein the virtual property has a virtual boundary based on a physical boundary of the physical object;
associate a unique identifier of the physical object with the virtual property, wherein the unique identifier uniquely identifies the geographical location of the physical object;
receive, from one or more client devices, a set of content files associated with the unique identifier;
associate the set of content files with the virtual property based on the unique identifier;
receive, from a client portable electronic device, a request for content files associated with the virtual property;
determine that the client portable electronic device is within a predetermined distance from the physical object; and
upon the determination, provide the set of content files associated with the virtual property to the client portable electronic device.

45. The non-transitory computer-readable storage medium of claim 44, wherein the computer processor is further enabled to:
determine that the set of received content files are related to the virtual property before associating the set of content files with the virtual property; and
storing the received content files.

46. The non-transitory computer-readable storage medium of claim 44, wherein the computer processor is further enabled to:
establish, for a moderating user account of a virtual property platform, moderating access rights for the virtual property and the set of content files.

47. The non-transitory computer-readable storage medium of claim 44, wherein the computer processor is further enabled to:
receive and storing visitor statistics, wherein the visitor statistics include for each visit of a visiting user account of a portable electronic device within the predetermined distance from the virtual property:
a visitor identification code, a visit start time and date, a visit duration and/or a visit end time and date, and a pointer to or copy of any content files generated by the visitor during the visit; and
provide access to the visitor statistics to the moderating user account.

48. The non-transitory computer-readable storage medium of claim 44, wherein the set of content files comprises at least one selected from a group consisting of a text file, an image file, a video file, and an audio file.
